(19) United States
(12) Patent Application Publication
(10) Pub. No.: US 2010/0169677 A1
(43) Pub. Date: Jul. 1, 2010

(54) Remotely Powering On-Off Network Devices via a Network Interface Device

(75) Inventor: Vishakh Madhusoodanan, Tamarac, FL (US)

Correspondence Address: Motorola, Inc.;Law Department, 1303 East Algonquin Road, 3rd Floor, Schaumburg, IL, 60196, US

(73) Assignee: MOTOROLA, INC., Schaumburg, IL (US)

(21) Appl. No.: 12/344,983

(22) Filed: Dec. 29, 2008

(51) Int. Cl. G06F 1/32

(52) U.S. Cl. 713/310; 713/323

(57) ABSTRACT

In general, in one aspect, the disclosure describes a network interface device (NID) that can be remotely instructed to power-up powered-down network devices by generating magic packets that instruct the powered-down network device to power-up and to broadcast the magic packets to the network devices connected thereto. Utilizing the NID to generate the magic packets means that the MAC ID is only broadcast within the network (more secure). The NID may configure the network devices that may be powered-on and any limitations thereto (e.g., user, remote device). The MAC IDs associated with the network devices may be stored in the NID so that the user need not know it. The NID may be remotely instructed to power-down powered-up network devices (generate and broadcast magic packets that instruct powered-up network devices to power-down) by a remote device having access to the NID.

### BACKGROUND

The use of wireless devices (e.g., portable computers, personal digital assistants (PDAs), cellular phones) is growing exponentially. Wireless devices may perform various operations and may be capable of wireless communications. Wireless devices may connect to a user's computer (e.g., work computer, home computer) for any number of reasons including, but not limited to, accessing data, running programs, and storing data. In order for a wireless device to communicate with a computer, the computer needs to be on. However, in order to save power a user may turn the power to their computer(s) off when they are not at home or in the office. Furthermore, the computers may include energy saving technology that places the computer in a powered-down state (e.g., sleep, deep sleep) when there has been no activity for some pre-defined period of time. Accordingly, a conflict exists between power savings and remote communications.

Wake-on-LAN (WOL) technology provides the ability to remotely power-up a powered-down computer and accordingly balances the desire to save power with the desire for remote communications (e.g., communications with wireless devices). The WOL technology provides power to a network interface card (NIC) even when the computer is in a powered-down state (e.g., off, sleep). When in the powered-down state the NIC can receive data packets and scan the data packets for an indication that the computer should be powered-up (power up message). The WOL technology may support an indication that includes a specific sequence followed by the media access control (MAC) address for the specific computer within the payload of the packets (known as magic packets). The MAC address is also known as a MAC address identifier or MAC ID, and those terms are used interchangeably herein. When the NIC determines that it has received magic packets destined for it, the NIC may cause the computer to enter a powered-up state.

A wireless device user can send the magic packets to a computer that they desire to turn-on so that they can communicate therewith. The wireless device may have a magic packet program stored thereon that can generate the magic packets (e.g., the desired sequence and the MAC address) and transmit the magic packets. Alternatively, the wireless device user may utilize a magic packet website in order to generate and transmit the magic packets. However the magic packets are generated, the user needs to know the MAC address of the computer they desire to turn on. Transmitting packets over the Internet that includes the MAC address of a computer within the payload of the packets may enable hackers to intercept the packets and indentify the MAC address of the computer. Accordingly, there is a conflict between security and the use of magic packets to remotely power-up a powered-down computer.

### SUMMARY

Network devices need to be powered-on in order for remote devices to communicate therewith. In order to conserve power the network devices may be powered-down when a user is not there or may enter a powered-down-state (e.g., sleep, deep sleep) if the network device has been inactive for a period of time. Network devices supporting Wake-on-Lan (WOL) technology can be awoken by a remote device if the remote device broadcasts a power-on message. The power-on message may include a wake sequence and the media access control (MAC) address of the network device within the payload of the packets (so called magic packets). Broadcasting the MAC ID in the payload presents a security risk.

In order to provide remote powering-on of powered-down network devices in a secure manner, a network interface device (NID) is utilized to generate and broadcast the power-on message (magic packets) that includes the MAC ID of the powered-down network device in the payload of the message to the network devices connected thereto. Utilizing the NID enables the magic packets (MAC ID) to be broadcast only within the network of the network device. The NID includes a power-on message generator (magic packet generator) and defines the network devices that may be powered-on (have magic packets generated for) within the configuration of the NID. The NID may have limitations (e.g., user, remote device) defined within the configuration regarding the remote powering on (generation of the magic packets). The MAC IDs associated with the network devices may be stored in the NID so that the user need not know it. The user may remotely login to the NID to instruct the NID to generate and broadcast the magic packets for a network device.

The NID may be capable of generating change in power state messages (e.g., power-down) and the network devices may be capable of changing their power state in response to the change in power state messages. The NID may be capable of being programmed with respect to the powering-on and/or off of network devices.

### BRIEF DESCRIPTION OF THE DRAWINGS

The features and advantages of the various embodiments will become apparent from the following detailed description in which:

FIG. 1 illustrates a system currently utilized to enable wireless devices to turn-on powered-down computers by broadcasting magic packets over the Internet;

FIG. 2 illustrates an example system enabling wireless devices to turn-on powered-down computers without the need to broadcast magic packets over the Internet, according to one embodiment;

FIG. 3 illustrates an example functional block diagram of a communication device that enables remote login and magic packet generation, according to one embodiment; and

FIG. 4 illustrates an example communication flow between a wireless device and a computer when the computer is in a powered down state, according to one embodiment.

### DETAILED DESCRIPTION

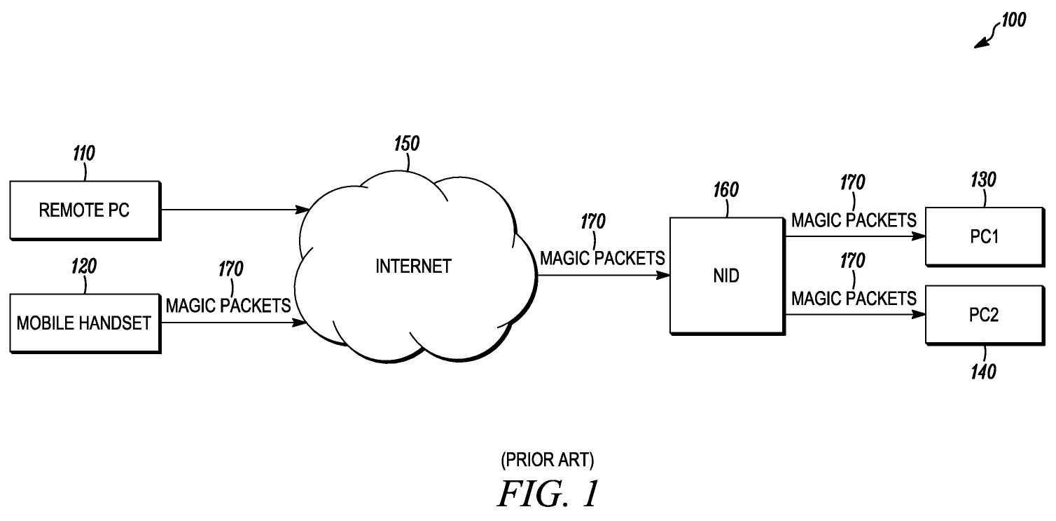

FIG. 1 illustrates a system 100 currently utilized to enable remote devices to turn-on powered-down network devices by broadcasting power on messages (magic packets). The system 100 includes remote devices 110, 120, network devices 130, 140, the Internet 150, and a network interface device (NID) 160 (e.g. modem, router, gateway). The remote devices 110, 120 are illustrated as wireless devices, specifically a remote computer 110 and a mobile handset 120, but are not limited thereto. In fact, the devices 110, 120 need not be wireless devices; they just need to be devices outside of the environment that the network devices 130, 140 are located (on the other side of the NID 160) that can access the Internet 150. The network devices 130, 140 are illustrated as computers but are not limited thereto. Furthermore, the network devices 130, 140 are illustrated as being wired devices that are directly wired to the NID 160 but need not be. Rather, the network devices 130, 140 could be wireless devices and could be indirectly connected to the NID 160 through over devices (e.g., hubs, routers, subnets).

Communications between the remote devices 110, 120 and the network devices 130, 140 is via the NID 160. The network devices 130, 140 may be network together and the NID 160 may provide the networking therebetween. The network devices 130, 140 may reside at a fixed location, the fixed location may be, for example, a residence or a business environment. If the network devices 130, 140 are located within a business environment, the NID 160 may be a server or the NID 160 may be connected to a server, where the server is maintained by the business to control communications between the network devices 130, 140 and the outside world (e.g., remote devices 110, 120). The business may use the server to regulate the type of communications that can occur between the network devices 130, 140 and the outside world.

The network devices 130, 140 may support wake-on-LAN (WOL) technology so that the network devices 130, 140 can be powered-on remotely when in a powered-down mode. The WOL technology includes network-interface-cards (NIC) that can receive at least limited power while the network device is in a powered-down mode. The NIC may be able to receive packets and perform some minimal processing of the packets, such as scanning the data packets for an indication that the computer should be powered-up (power up message). The WOL technology may support the indication being magic packets (a specific sequence followed by the media access control (MAC) address for the specific computer within the payload of the packets). The exact manner in which the NIC remains powered on in a powered-down state and the NIC is connected with the network device (e.g., motherboard) and initiates the powering on of the network devices may vary based on manufacture and/or implementation.

If a user is external to the location (e.g., remote) and utilizing, for example, the mobile handset 120 and desires to communicate with, for example, the first computer 130, the first computer 130 needs to be powered ON. If the first computer 130 is in a powered-down state (e.g., off, sleep), the user may send magic packets 170 to the first computer 130 in order to power-up the first computer 130 so that communications with the mobile handset 120 can occur. In order to generate the magic packets 170 the user needs access to a magic packet program (e.g., running on the mobile handset 120, the mobile handset 120 accessing via a website) and needs to know the MAC ID of the first computer 130. The user may enter the MAC ID of the first computer 130 into the magic packet program.

Alternatively, the magic packet program may include a storage means (e.g., register, database) or may access a storage means that associates network devices the user may wish to remotely turn ON with the MAC ID of the network devices. If the user identified the first computer 130 (e.g., by name) the magic packet program may look up the first computer 130 to determine what the MAC ID is for the first computer 130. The user simply identifies the first computer 130 and the MAC ID is retrieved and inserted in the magic packets. In either event, the MAC ID of the first computer 130 is documented remotely with the user and could be obtained by others who could use it for unauthorized access or use of the first computer 130.

Since the Internet Protocol (IP) address of the first computer 130 is likely static the magic packets 170 are typically broadcast. If the magic packets 170 were not broadcast they may not be received, as the NID 160 (e.g., router) may not have a valid IP address defined for the first computer 130. The NID 160 may therefore broadcast an address resolution protocol (ARP) message to the nodes connected thereto in order to determine the IP address of the first computer 130. If the first computer 130 is powered down, the first computer 130 will not respond to the ARP message and the NID 160 (e.g., router) may discard the magic packets 170 since there is no active communication with the first computer 130. As illustrated, the magic packets 170 are broadcast from the NID 160 to each of the computers 130, 140 connected thereto even though they are only intended for the first computer 130. Requiring the magic packets to be broadcast may create some implementation issues as the NID 160 may be programmed to discard broadcast messages as these type of messages may typically be undesirable (e.g., spam), particularly in a business environment. For security reasons business environments may disable the use of magic packets 170 from remote locations.

The NIC in the second computer 140 that the magic packets are not destined for may simply ignore the magic packets 170 since the MAC ID in the magic packets 170 does not match the MAC ID of the second computer 140. The NIC in the first computer 130 that the magic packets 170 are destined for may determine that the magic packets 170 are intended therefore by verifying that the MAC ID in the magic packets 170 match the MAC ID of the first computer 130. The NIC may then proceed to wake up the first computer 130.

The payload of the magic packets 170 may follow a standard format (e.g., a 6-digit sequence followed by the MAC ID repeated sixteen times). Transmitting the MAC ID within the payload of the magic packets 170 may enable hackers to intercept the message and obtain the MAC ID for the first computer 130 the magic packets 170 are destined. The hacker may intercept the magic packets 170 at any number of points as they traverse the Internet 150 in their path to the first computer 130. The hacker may utilize the MAC ID for unauthorized access or use of the first computer 130.

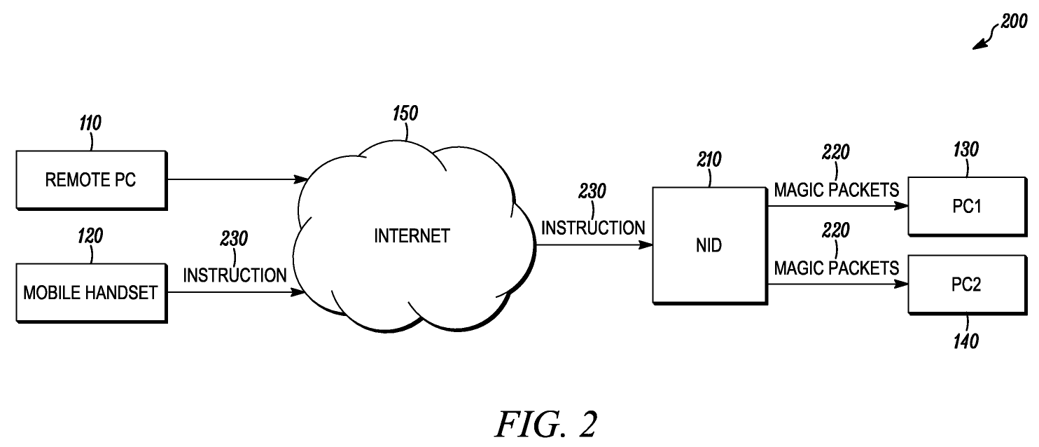

FIG. 2 illustrates an example system 200 enabling remote devices to turn-on powered-down network without the need to broadcast magic packets over the Internet 160, according to an embodiment. The system 200 includes a NID 210 (e.g. modem, router, gateway) providing the communication link between the Internet 150 and the network devices 130, 140. The NID 210 may include a communication port for receiving data from and transmitting data to the Internet 150. The NID 210 may also include one or more communications ports for receiving data from and transmitting data to the network devices 130, 140. The NID 210 may include a wireless transceiver to wirelessly communicate with the network devices 130, 140. The NID 210 may modulate/demodulate messages to and from the Internet 150.

The NID 210 may provide remote access thereto. The remote access may include the capability of instructing the NID 210 to generate the power on messages (magic packets) 220. If a user of a remote device (e.g., mobile handset 120) desires to communicate with a network device (e.g., the first computer 130) that is in a powered-down state, they may remotely access the NID 210 and provide instructions 230 to the NID 210 to power-on the first computer 130. The NID 210 may turn the first computer 130 on by generating the magic packets 220 for the first computer 130 and transmitting the magic packets 220 to the first computer 130. The magic packets 220 may be broadcast from the NID 210 in order to ensure that they are received by the first computer 130 since the IP address of the first computer 130 may not be known.

In order for the NID 210 to generate the magic packets 220 a power-on message (magic packet) generation program must be incorporated into the NID 210. Having the NID 210 generate the magic packets 220 means that the MAC ID of the first computer 130 will only be contained within the magic packets 220 transmitted internal to the location that the computers 130, 140 are located. Presumably, the location would have some type of firewall that prevented hackers from accessing messages being communicated therewithin. The magic packet generator may require the user to identify the device they wish to wake (e.g., the first computer 130) and enter the MAC ID for the device. Alternatively, the NID 210 could store the MAC IDs for the devices connected thereto in a storage means (e.g., register) so that the user was not required to have it documented remotely. That is, the user could simply identify the first computer 130 (e.g., by name) and the NID 210 could determine the MAC ID for the first computer 130 (e.g., look it up in the storage means) and utilize the MAC ID in the generation of the magic packets 220.

The NID 210 may limit the devices that magic packets 220 can be generated for. A user may log into the NID 210 to define the configuration of the network devices connected thereto and to set various parameters that may include identifying what network devices can be remotely powered on (magic packets can be generated for). The user may also provide limitations to when the identified network devices can have magic packets generated for. The limitations may be based on, for example, user and remote device. A limitation by user may, for example, entail enabling parents to generate magic packets to remotely turn on any network device while kids are limited to a specific network device (determination based on user login). A limitation by remote device may, for example, entail limiting the generation of magic packets to remote computers (e.g., restrict magic packets from handheld devices). In business environments, the restriction of the devices that magic packets can be generated for may be complex. The NID 210 for a business may be a server or may be connected to a server to provide the necessary restrictions. The control provided by the NID 210 (e.g., server) may allow businesses that typically would not allow remote powering-on of network devices via magic packets to allow it due to the added security.

The mobile handset 120 may provide the instructions 230 to the NID 210 by remotely logging into the NID 210. Remotely logging in to the NID 210 can be done in any number of ways that are well known to those skilled in the art. The remote login may entail various security features that are well known to those skilled in the art. The NID 210 may enable remote login for any number of additional reasons (e.g., configuration) other than the generation of magic packets 220. Remote access to the NID 210 and the functions that may be available during remote access may be controlled by the configuration and parameters (e.g., user, wireless device, network configuration) defined therein.

When the user of a remote device begins the remote log in to the NID 210 they may be provided with a user interface on their wireless device. The user interface may prompt the user for information (e.g., user ID and password) to validate they can remotely access the NID 210. Once the user is validated they may be provided with a user interface that presents the options available to the user. One of the options may be to power on (have magic packets generated for) identified network devices. The user may select power on and then be provided with a list of network devices that may be remotely powered on (limited to those the user may be authorized to power on). When the user selects, for example, the first computer 130 to be powered on, the NID 210 may retrieve the MAC ID for the first computer 130 and generate the magic packet 220 for the first computer 130 (e.g., insert defined string and MAC ID in the payload). Alternatively, the user may provide the MAC ID to the NID 210. The user interface is not limited to any specific presentation or sequence of presentations.

According to one embodiment, the mobile handset 120 may be able to direct the NID 210 to generate magic packets by sending the NID 210 the instructions 230 within a command (or series of commands). As the NID 210 is likely powered on a command sent to the NID 210 need not be broadcast and the command may include additional security that is well known in the art. The NID 210 may receive a command from the mobile handset 120 and validate the command (e.g., valid command type, authorized user). The NID 210 needs to be configured to accept remote commands (e.g., generate magic packets for a specific device connected thereto). Once the command is validated, the NID 210 may determine if the action specified in the command can be taken (e.g., user enabled to send magic packets, computer enabled to receive magic packets, computer connected thereto, MAC ID identified for computer). If the NID 210 determines the action can be taken, the NID 210 takes the action specified (e.g., prepares magic packets for specified device and broadcasts them). The NID 210 may send the mobile handset 120 messages indicating the status of the command processing (e.g., user not authorized for command, unknown command, command processed).

Regardless of how the mobile handset 120 provides the instructions 230 to the NID 210 (e.g., remote login, commands) the mobile handset 120 does not need access to a magic packet program and the user does not need to know anything about magic packets. The mobile handset 120 and the user simply need access to the NID 210 in order to provide the instructions thereto.

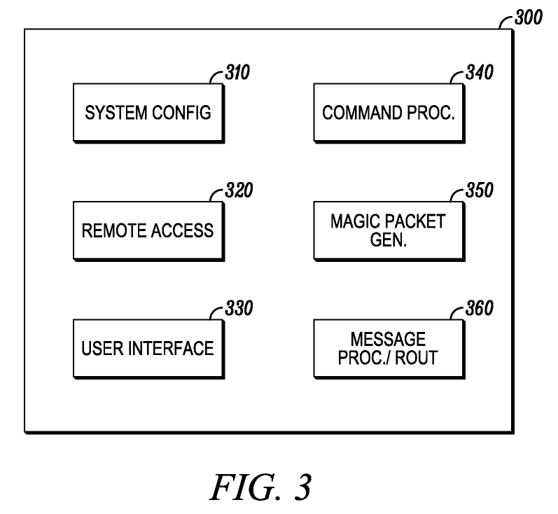

FIG. 3 illustrates an example functional block diagram of a NID 300 that enables remote login and magic packet generation, according to an embodiment. The NID 300 may include functions to provide system configuration 310, remote access (login) 320, user interface 330, command processing 340, magic packet generation 350 and message processing/routing 360. The system configuration function 310 enables the user to configure the NID. The configuration may include, but is not limited to, defining the computers that are connected thereto, identifying the MAC ID for each of the computers, defining what type of processing can be performed for each computer (e.g., whether remote login can be performed or magic packets can be sent), and defining any limitations associated with specific users or wireless devices. The computer to MAC ID association may be stored in the NID and utilized when a user (e.g., remote user) requests the NID to turn on a computer connected thereto.

The remote access function 320 may provide the ability for a user to login to the system remotely. Once a user is logged in remotely they may be able to configure the NID or to instruct the NID to do certain functions (generate magic packets for devices connected thereto in order to turn the devices on). The user interface function 330 may present various views that are presented to remote users. The user interface views may enable the user to login, configure the NID, or select certain functions for the NID to perform (e.g., generate magic packets). The command processing function 340 may recognize commands received remotely, validate the commands and then act on the commands. The commands may direct the NID 300 to perform certain functions (e.g., generate magic packets).

The magic packet generation function 350 may generate the magic packets for the network device identified. The magic packet generation program 350 may look up the MAC ID for the network device identified and utilize the looked up MAC ID in the magic packets that are generated and sent (e.g., broadcast) to the network device. Alternatively, if the MAC ID to network device association was not known to the NID (e.g., not part of configuration) the user could be prompted for the MAC ID.

The message processing/routing function 360 receives the messages destined for network devices connected thereto from the Internet, demodulates the messages and routes the messages to the appropriate network devices. The processing/routing function 360 receives messages from network devices connected thereto, modulates the messages, and transmits the messages to the Internet.

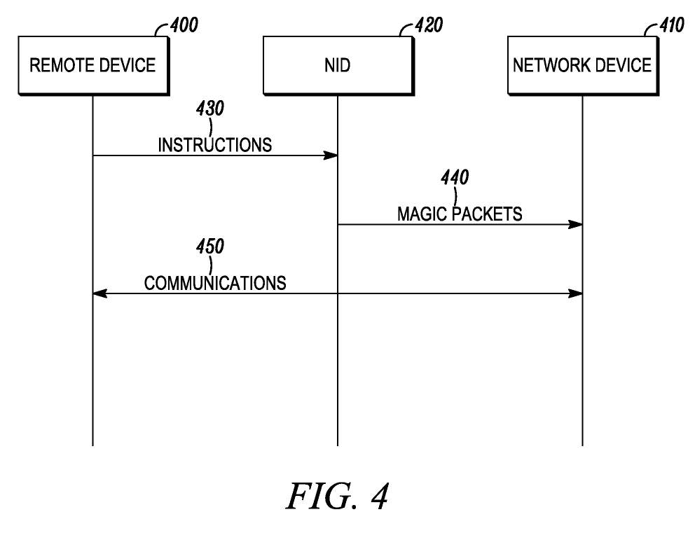

FIG. 4 illustrates an example communication flow between a remote device 400 (e.g., wireless device) and a network device 410 (e.g., computer) when the network device 410 is in a powered down state, according to an embodiment. The communications between the remote device 400 and the network device 410 may be over the Internet where a NID 420 provides the demodulation/modulation of the communications therebetween. The remote device 400 may instruct 430 the NID 420 to turn on the network device 410. The instructions 430 may include the remote device 400 logging into the NID 420 in order to provide the instructions. For example, the user may provide the instruction from a user interface that is provided (e.g., select from a menu) when the user is remotely logged in. The remote login process may include multiple messages back and forth between the NID 420 and remote device 400 but for simplicity, these are not illustrated. Alternatively, the instructions 430 may include commands sent from the remote device 400 to the NID 420.

Once the NID 420 validates the instructions 430, the NID 420 generates the magic packets 440 and broadcasts the magic packets 440 to the network device 410. The network device 410 receives the magic packets 440 and enters a powered-on state. The NID 420 may determine the network device 410 acted on the magic packets and has been powered on in any number of ways that would be known to those skilled in the art (e.g., the NID 420 may send a ARP message after some defined period of time). If the NID 420 determines that the network device 410 was not powered-on, it may reattempt to power-on the network device 410 by broadcasting the magic packets 440 again. The NID 420 may inform the remote device 400 that the network device 410 is in powered-on state (or that the network device 410 remains in a powered-off state if it is determined that the magic packets were unsuccessful at powering-on the network device 410). Any messages exchanged between the NID 420 and the network device 410 and remote device 400 regarding confirmation that the network device 410 has been powered-on or notice that the network device 410 is still powered-down are not illustrated for simplicity.

In an alternative embodiment, the remote device 400 may not be notified about the powered status (powered-up, powered-down) of the network device 410. Rather, the remote device 400 may simply attempt to communicate with the network device 410 (after some period). Once the network device 410 is powered on communications 450 between the network device 410 and the remote device 400 can occur.

FIG. 2 focused on the remote powering on of computers (e.g., 130, 140) by wireless devices (e.g., 110, 120) but the disclosure is in no way intended to limited to wireless devices or computers. Rather, the remote powering on can be initiated from any network device remotely located that is capable of communicating with the NID 210 (herein referred to collectively as “remote devices”). For example, the user could be at another facility and utilize a desktop computer as the remote device to communicate with the NID 210 or the remote device could be a dumb terminal. The devices capable of being remotely powered on may be any network device having WOL capability that the NID 210 is capable of communicating with (herein referred to collectively as “network devices”). For example, network devices having WOL capability may include, but are not limited to, televisions, stereo's, DVRs, set-top boxes, fax machines and printers.

The powering on of powered-down network devices may be performed so that the remote devices can communicate with the network devices for any number of reasons. For example, a user of a remote device (e.g., laptop computer) may be running out of storage space and wish to download (transfer) some of their contents to a network device (e.g., hard drive) to free up space. A user may wish to download content (e.g., pictures) from their remote device to a network device (e.g., digital picture frame) in order to share the content or for redundant storage of the content. A remote user may wish to access content (e.g., a database) or run a program contained on a networked computer. A remote user may wish to have audio/video content from their entertainment system streamed to their remote device for viewing. A remote user may power on a networked fax machine or networked printer in order to receive a fax or print a document.

The disclosure has focused on the powering-up of powered down network devices but is not limited thereto. For example, the WOL technology could be expanded so that the NIC recognizes additional types of magic packets and the NID could be enabled to generate the additional types of magic packets. The use of additional types of magic packets is more likely to be implemented since the NID provides the MAC IDs (the MAC ID is only broadcast within the location). The additional types of magic packets may follow the same structure as the power-on magic packets except new sequences may be defined that would indicate what action the NIC should take.

For example, the additional type of magic packets may be used to power-down (power-off) network devices. Power-down magic packets could be utilized by a remote user to power down a network device that they left on that they realize they should have powered down (e.g., power off entertainment system). As with the power-up magic packets, a remote user may either login to the NID or send commands to the NID to instruct the NID to generate the power-down magic packets for a defined network device.

The additional type of magic packets may be utilized to change (e.g., increase or decrease) the power state (e.g., so-called core-states (C-states) of computers) of the network devices. Changing the power state remotely may enable remote conservation of battery life or energy.

The disclosure has focused on the NID 210 generating the magic packets at the point in which the instructions are received, but is not limited thereto. For example, the instructions may instruct (configure) the NID 210 to generate magic packets (power-up, power-down) based on certain conditions (e.g., at defined times/intervals, when a certain event occurs). For example, the user may instruct the NID 210 to power-on (generate and broadcast power-up magic packets to) a networked DVR at or before the planned start of a show and to power-off (generate and broadcast power-down magic packets to) at or after the planned end time. The user may instruct the NID 210 to power-off a device at some defined period after it powers on the device (e.g., power-off a networked fax machine half an hour after powering on as that should be enough time to receive fax). The NID 210 may include clocks, counters and/or event trackers (collectively referred to as condition trackers) in order to determine when configured conditions have occurred and to trigger the generation and broadcast of the magic packets.

The disclosure has focused on the use of magic packets that include a sequence and MAC ID in the payload and WOL technology that utilize the magic packets but is not limited thereto. When used herein the term “magic packet” shall encompass WOL magic packets, some other proprietary packets or packets of other technologies that can instruct the NIC to take some action on the network device.

Although the disclosure has been illustrated by reference to specific embodiments, it will be apparent that the disclosure is not limited thereto as various changes and modifications may be made thereto without departing from the scope. Reference to “one embodiment” or “an embodiment” means that a particular feature, structure or characteristic described therein is included in at least one embodiment. Thus, the appearances of the phrase “in one embodiment” or “in an embodiment” appearing in various places throughout the specification are not necessarily all referring to the same embodiment.

The various embodiments are intended to be protected broadly within the spirit and scope of the appended claims.

What is claimed is:

1. A network interface device (NID) to provide a communication link between network devices and remote devices via the Internet, wherein the NID includes a change power state message generator to generate a change of power state message for a first network device based on instructions received from a first remote device and broadcasts the change of power state message to the network devices.

2. The NID of claim 1, wherein the change of power state message is a power-on message.

3. The NID of claim 1, wherein the change of power state message is a power-off message.

4. The NID of claim 1, wherein the change of power state message includes a defined sequence representing the change of power state and a media access control address identifier (MAC ID) of the network device.

5. The NID of claim 4, wherein the instructions received from the first remote device include the MAC ID for the first network device.

6. The NID of claim 4, further comprising a storage means to associate the network devices with their MAC IDs, wherein the instructions received from the first remote device identify the first network device and the change power state message generator looks up the MAC ID for the first network device in the storage means.

7. The NID of claim 1, further comprising remote login access, wherein a user of the first remote device remotely logs into the NID to provide the instructions.

8. The NID of claim 1, wherein the instructions define certain conditions that should trigger the change power state message generator to generate a change of power state message, and further comprising a condition tracker to determine when the certain conditions have occurred and to trigger the change power state message generator.

9. A method to enable remotely changing the power state of a network device, the method comprising
receiving, at a network interface device (NID), instructions from a remote device to change power state of a network device;
generating, in the NID, magic packets to change power state of the network device; and
broadcasting the magic packets from the NID to all devices connected to the NID.

10. The method of claim 9, further comprising validating the instructions in the NID.

11. The method of claim 9, further comprising configuring the NID to define the network devices that can have the power state remotely changed.

12. The method of claim 9, wherein the receiving includes providing remote access to the remote device and receiving the instructions during the remote access.

13. The method of claim 9, further comprising
configuring the NID to associate each of the network devices connected thereto with a media access control address identifier (MAC ID) assigned thereto; and
retrieving the MAC ID for the network device identified in the instructions, wherein the generating including using the retrieved MAC ID in the magic packets.

14. The method of claim 9, wherein the receiving includes receiving instructions that define certain conditions that should trigger the generating, and further comprising tracking the certain conditions.

15. The method of claim 9, wherein the receiving includes receiving power on instructions and the generating includes generating power on magic packets.

16. The method of claim 9, wherein the receiving includes receiving power off instructions and the generating includes generating power off magic packets.

17. The method of claim 9, further comprising confirming that the network device has changed power state.

18. A system comprising
a plurality of network devices, wherein a subset of the plurality of network devices include network interface cards that receive limited power and are capable of limiting processing of packets during a powered down state of the network device;
a network interface device (NID) in communication with the plurality of network devices to provide a link to remote devices via the Internet, wherein the NID includes a magic packet generator to generate power-on magic packets and broadcast the power-on magic packets to the plurality of network devices, wherein the power-on magic packets include a power-on sequence and a media access control address identifier (MAC ID) of an associated network device; and
at least one remote device capable of instructing the NID to generate the power-on magic packets for one of the subset of the plurality of network devices.

19. The system of claim 18, wherein the NID includes a storage means to associate the subset of network devices with their MAC IDs, wherein the magic packet generator looks up the MAC ID for the one of the subset of the plurality of network devices.

20. The system of claim 18, wherein the at least one remote device is capable of instructing the NID to generate the power-on magic packets when certain conditions occur and the NID is capable of tracking the certain conditions.
